(19) United States
(12) Patent Application Publication
(10) Pub. No.: US 2013/0097381 A1
(43) Pub. Date: Apr. 18, 2013

(54) MANAGEMENT APPARATUS, MANAGEMENT METHOD, AND PROGRAM

(71) Applicant: SONY CORPORATION, Tokyo (JP)

(72) Inventor: Hirokazu KOMATSU, Kanagawa (JP)

(73) Assignee: SONY CORPORATION, Tokyo (JP)

(21) Appl. No.: 13/650,364

(22) Filed: Oct. 12, 2012

(30) Foreign Application Priority Data
Oct. 17, 2011 (JP) 2011-227957

(51) Int. Cl. G06F 12/08

(52) U.S. Cl. 711/118; 711/E12.017

(57) ABSTRACT

There is provided a management apparatus including a management unit that manages, based on execution control information indicating an execution sequence of a plurality of applications, an execution area and a cache area of a recording medium which temporarily stores the applications when the applications are executed.

### BACKGROUND

The present disclosure relates to a management apparatus, a management method, and a program.

Memory management is becoming more and more important in effectively utilizing restricted calculation resources or implementing efficiency of processes to be performed. Accordingly, various technologies regarding memory management have been developed. For example, the technology disclosed in Japanese Patent Application Laid-Open No. 2010-282252 can be exemplified as one of the technologies regarding memory management.

### SUMMARY

For example, when a plurality of applications (software) are sequentially executed and processes are sequentially performed by the executed applications, efficient memory management is preferably performed, for example, to implement the efficiency of the processes and switch between the executed applications at a higher speed.

An apparatus using the technology (hereinafter, also referred to as “the related art”) regarding the memory management disclosed in for example, Japanese Patent Application Laid-Open No. 2010-282252 includes a memory management unit (MMU) and rewrites table entries to generate a page fault for all of the pages necessary in processes of applications in a table used by the MMU. The apparatus using the related art sequentially reads pages in which a page fault is generated with the table entries of the pages, when the applications operate. Accordingly, when the related art is used, unnecessary pages are not read. Therefore, there is a probability that the operation time of the application can be shortened h a time in which the unnecessary pages are not read.

However, for example, the related art may not be used when software, such as an operating system (OS) having the concept of the page fault, which is able to process the page fault, is not used. Accordingly, the related art is not versatile. Therefore, even when the related art is used, efficient memory management may not be realized When a plurality of applications are sequentially executed.

It is desirable to provide a novel and improved management apparatus, management method, and program capable of performing efficient memory management when a plurality of applications are sequentially executed.

According to an embodiment of the present disclosure, there is provided a management apparatus including a management unit that manages, based on execution control information indicating an application execution sequence of a plurality of applications, an execution area and a cache area of a recording medium which temporarily stores the applications when the applications are executed.

According to another embodiment of the present disclosure, there is provided a management method including managing, based on execution control information indicating an application execution sequence of a plurality of applications, an execution area and a cache area of a recording medium which temporarily stores the applications when the applications are executed.

According to still another embodiment of the present disclosure, there is provided a program causing a computer to realize a function of managing, based on execution control information indicating an application execution sequence of a plurality of applications, an execution area and a cache area of a recording medium which temporarily stores the applications when the applications are executed.

According to the embodiments of the present disclosure described above, it is possible to perform efficient memory management when a plurality of applications are sequentially executed.

### BRIEF DESCRIPTION OF THE DRAWINGS

FIG. 1 is a diagram for describing an example of the configuration of a recording medium that temporarily stores applications managed by a management apparatus according to an embodiment;

FIG. 2 is a diagram for describing an exemplary process in a management method of the management apparatus according to the embodiment;

FIG. 3 is a diagram for describing an exemplary process in a management method of the management apparatus according to the embodiment;

FIG. 4 is a diagram for describing an exemplary process in a management method of the management apparatus according to the embodiment;

FIG. 5 is a diagram for describing an exemplary process in a management method of the management apparatus according to the embodiment;

FIG. 6 is a diagram for describing an exemplary process in a management method of the management apparatus according to the embodiment;

FIG. 7 is a diagram for describing an exemplary process in a management method of the management apparatus according to the embodiment;

FIG. 8 is a block diagram illustrating an exemplary configuration of the management apparatus according to the embodiment; and

FIG. 9 is a diagram for describing an exemplary hardware configuration of the management apparatus according to the embodiment.

### DETAILED DESCRIPTION OF THE EMBODIMENTS

Hereinafter, a preferred embodiment of the present disclosure will be described in detail with reference to the accompanying drawings. Throughout the specification and the drawings, the same reference numerals are given to constituent elements having substantially the same function and the description thereof will not be repeated.

The description will be made below in the following order.

1. Management Method According to Embodiment

2. Management Apparatus According to Embodiment

3. Program According to Embodiment

### Management Method According To Embodiment

Before the configuration of a management apparatus according to the embodiment is described, a management method according to the embodiment will be described. Hereinafter, the description will be made on the assumption that the management apparatus according to the embodiment (hereinafter, also referred to as “management apparatus 100”) performs processes of the management method according to the embodiment.

### Overview of Management Method According To Embodiment

The management apparatus 100 according to this embodiment specifies an application execution sequence based on execution control information to perform efficient memory management when a plurality of applications are sequentially executed. The management apparatus 100 manages an execution area and a cache area of a recording medium that temporarily stores applications when the applications are executed (management process). Here, the execution area according to this embodiment refers to a memory area in which applications to be executed are arranged. Further, the cache area according to this embodiment refers to a memory area in which a plurality of applications are stored to switch between the applications at a high speed and with efficiency, when the plurality of applications are switched between and executed.

More specifically, the management apparatus 100 appropriately reads an application indicated by execution control information from a magnetic recording medium such as a hard disk or a non-volatile memory such as a NAND flash memory, and then records the application on a recording medium to be managed. For example, the management apparatus 100 may also read an application stored in an external apparatus connected via a network (or connected directly). Then, the management apparatus 100 manages the execution area and the cache area of the recording medium by performing logical address-physical address conversion. Here, the management apparatus 100 realizes the logical address-physical address conversion, for example, by updating a logical address-physical address conversion table. The management process performed by the management apparatus 100 according to this embodiment W be described in detail later, giving specific examples.

Here, for example, the execution control information according to this embodiment refers to data that indicates an application execution sequence of a plurality of applications. Data in which an identifier (for example, an application ID) indicating an application and a number indicating an application execution sequence correspond to each other can be used as an example of the execution control information. However, the execution control information according to this embodiment is not limited thereto. For example, the execution control information may include data (for example, data indicating a file path or a link such as a hyperlink) indicating a location in which an application is stored.

For example, the management apparatus 100 specifies an application execution sequence based on the execution control information transmitted from an external apparatus. Here, an apparatus that transmits a process execution request for executing an application, that is, an apparatus that substantially controls executing of an application, can be exemplified as the external apparatus. A server managing a service or a point-of-sale (POS) system can be exemplified the apparatus that substantially controls executing of an application.

The embodiment of the present disclosure is not limited to the case in which the management apparatus 100 specifies the application execution sequence based on the execution control information transmitted from an external apparatus. For example, the management apparatus 100 according to this embodiment can generate the execution control information based on a user's operation using an operation unit (which will be described later), and specify the application execution sequence based on the generated execution control information.

A random access memory (RAM) can be exemplified as the recording medium according to this embodiment. The recording medium according to this embodiment is not limited thereto. For example, any device that, like a RAM, is capable of reading and writing data at a higher speed than a NAND flash memory, a hard disk, or the like may be used. Further, the recording medium according to this embodiment may be a recording medium included in the management apparatus 100 or an external recording medium installed outside the management apparatus 100.

The management apparatus 100 according to this embodiment can execute an application stored in the execution area of the recording medium and cause the executed application to perform a process (execution process). Here, for example, an application stored in the execution area of the recording medium according to this embodiment refers to an application arranged in logical addresses corresponding the execution area of the recording medium.

More specifically, the management apparatus 100 causes an application to perform a process, for example, in response to a process execution request transmitted from an external apparatus having transmitted execution control information or a process execution request generated based on a user's operation. Here, the process execution requests according to this embodiment are transmitted or generated sequentially for the applications in the sequence indicated b the execution control information. Further, in the management process, the management apparatus 100 arranges an application to be executed in the execution area of the recording medium based on the execution contra information. Accordingly, the management apparatus 100 can execute an application corresponding to the process execution request at a higher speed and cause the application to perform a process.

For example, the management apparatus 100 according to this embodiment performs processes (I) (management processes) or performs the processes (I) (management processes) and processes (II) (execution processes) as processes of the management method according to this embodiment.

### Specific Examples of Processes of Management Method According To Embodiment

Next, the processes of the management method of the management apparatus 100 according to this embodiment will be described in more detail. Hereinafter, the description will be made giving an example in which the management apparatus 100 manages a RAM (which is an example of a recording medium that temporarily stores applications to be executed) included in the management apparatus 100 and appropriately reads an application from a non-volatile memory included in the management apparatus 100.

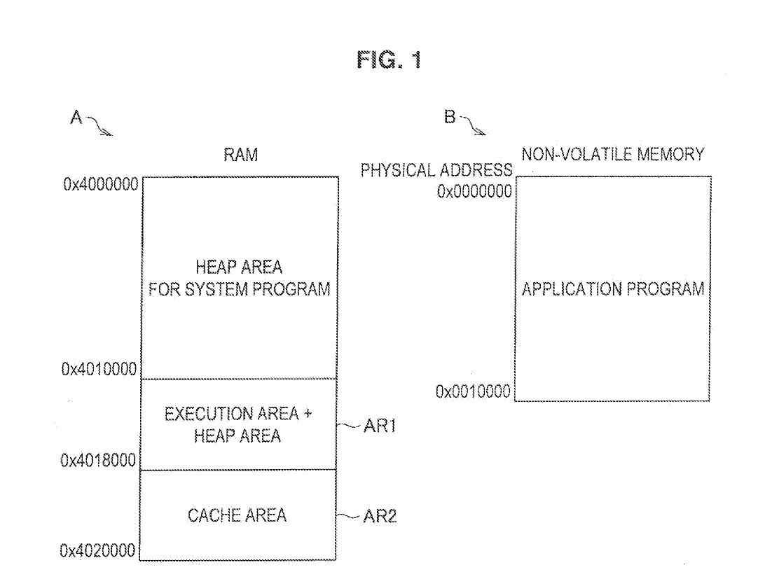

FIG. 1 is a diagram for describing an example of the configuration of the recording medium that is managed by the management apparatus 100 according to this embodiment and temporarily stores applications or the like. Here, FIG. 1 shows a RAM (indicated by A in FIG. 1) as a recording medium that temporarily stores applications and a non-volatile memory (indicated by B in FIG. 1) by which applications are appropriately read.

For example, the RAM includes a heap area for a system program, an execution area AR1, and a cache area AR2. FIG. 1 shows an example that the execution area AR1 and the cache area AR2 each have 512 [Kbyte]. The execution area AR1 according to this embodiment may serve as a heap area of an application.

The heap area for a system program in the RAM shown in FIG. 1 is used by, for example, a system program stored in a read-only memory (ROM) (not shown) included in the management apparatus 100. Here, the system program according to this embodiment is, for example, software that is used for control of the entire management apparatus 100. The management apparatus 100 installs an application in the non-volatile memory through the executed system program. For example, the management apparatus 100 can uniquely specify the application indicated by the execution control information in the non-volatile memory by installing the application in the non-volatile memory through the system program. For example, when the application indicated by the execution control information is not stored in the non-volatile memory, the management apparatus 100 may, of course, acquire this application from an external apparatus such as a server and store this application.

Hereinafter, the processes of the management method according to the embodiment will be described, giving an example in which the management apparatus 100 manages the execution area AR1 and the cache area AR2 of the RAM shown in FIG. 1 based on the execution control information and executes applications arranged in the execution area AR1 in response to a process execution request transmitted from an external apparatus. However, the processes of the management method of the management apparatus 100 according to this embodiment are not limited thereto. For example, the management apparatus 100 according to this embodiment may manage the execution area AR1 and the cache area AR2 of the RAM shown in FIG. 1 based on the execution control information and an external apparatus may execute the application arranged in the execution area AR1.

Hereinafter, the processes of the management method according to this embodiment will be described, giving an example in which three applications, Application 1 to Application 3 to be described below, are executed and processes of payment using electronic money (which is a kind of electronic value) are performed. Hereinafter, the description will be made, giving an example in which the execution control information indicates the sequence of Application 1, Application 2, and Application 3, that is, Application 1, Application 2, and Application 3 are executed in this sequence.

### Application 1

Application 1 is an application that is used to make payment using electronic money. The program size (data size) of Application 1 is assumed to be 384 [Kbyte].

### Application 2

Application 2 is an application that grants points (which is an exemplary service) corresponding to the payment using the electronic money. For example, Application 2 records the points on an internal recording medium inside an IC (Integrated Circuit) chip of an IC card. The program size (data size) of Application 2 is assumed to be 64 [Kbyte].

### Application 3

Application 3 is an application that grants points (which is an exemplary service provided by a store) corresponding to the store in which the payment is made using the electronic money. For example, Application 3 records the point on an internal recording medium inside an IC (Integrated Circuit) chip of an IC card. The program size (data size) of Application 3 is assumed to be 256 [Kbyte].

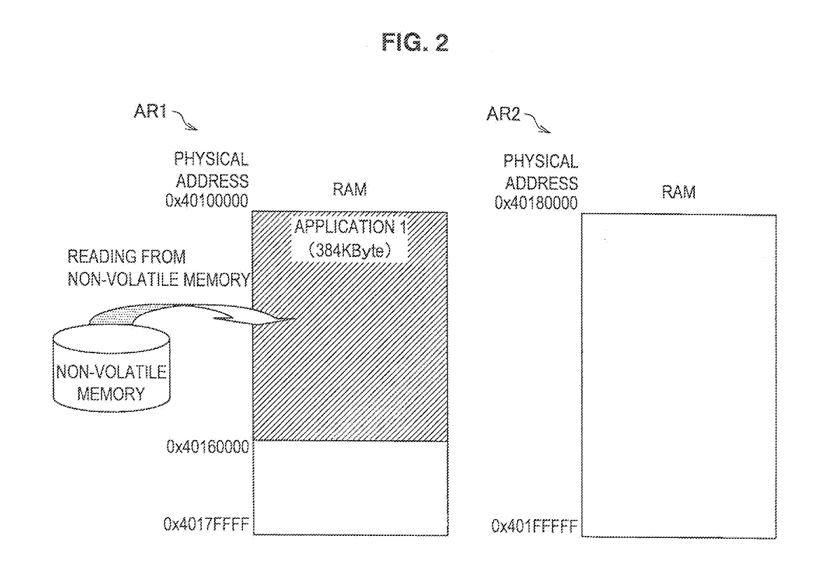

FIGS. 2 to 7 are diagrams for describing examples of the processes of the management method of the management apparatus 100 according to this embodiment. Here, FIGS. 2 to 7 show examples of the states of the execution area AR1 and the cache area AR2 of the RAM shown in FIG. 1. Hereinafter, examples of the processes of the management method of the management apparatus 100 will be described appropriately with reference to FIGS. 2 to 7. Of the processes performed by the management apparatus 100 to be described below, processes of executing an application correspond to the processes (II) (execution processes) and the other processes correspond to the processes (I) (management processes).

### (1) Arrangement of Application 1 In Execution Area AR1 (See FIG. 2)

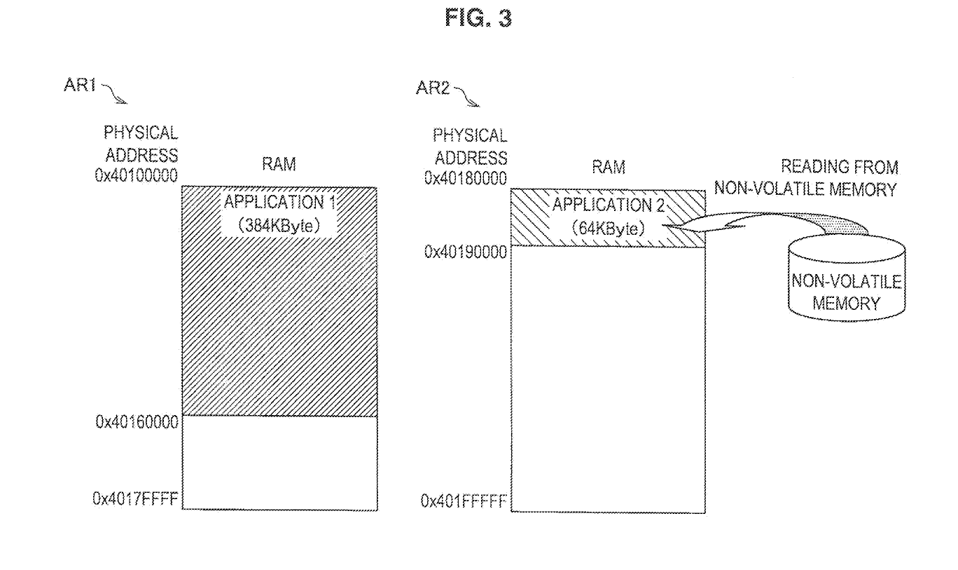

The management apparatus 100 reads Application 1 to be executed first from the non-volatile memory based on the, execution control information and records Application 1 in the execution area AR1 of the RAM. Here, the management apparatus 100 records Application 1 using the physical address of the beginning of the execution area AR1 as a recording start position, as shown in FIG. 3. In FIG. 3, the physical address and the logical address of the RAM are assumed to coincide. The management apparatus 100 does not execute Application 1 arranged in the execution area AR1 until the management apparatus 100 receives a process execution request corresponding to Application 1.

### (2) Arrangement of Application 2 In Cache Area AR2 (See FIG. 3)

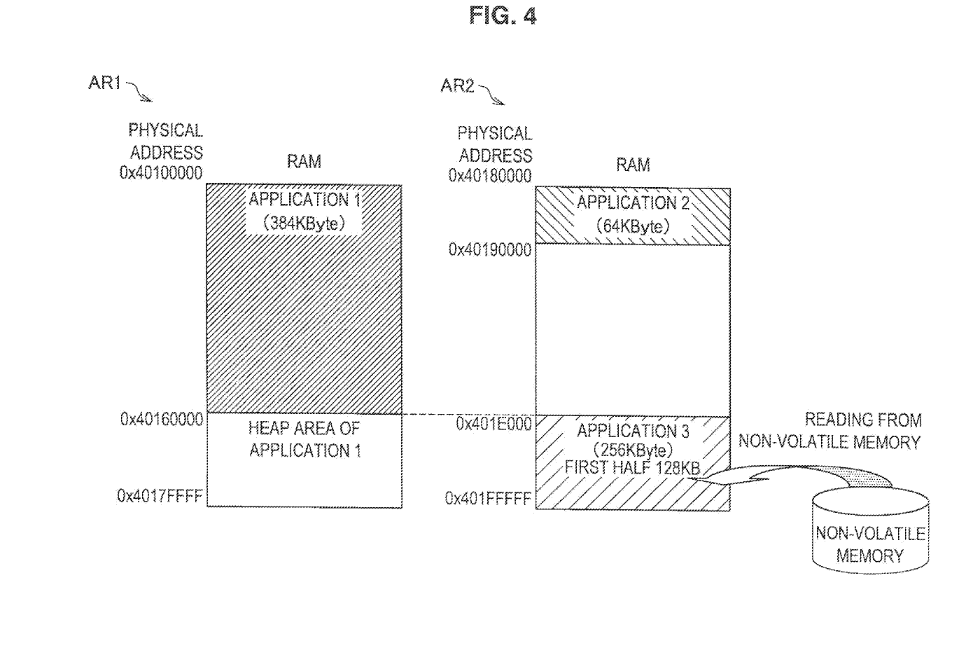

When the management apparatus 100 completes the arrangement of Application 1 in the execution area AR1, the management apparatus 100 reads Application 2 to be executed second from the non-volatile memory based on the execution control information and records Application 2 in the cache area AR2 of the RAM. Here, as shown in FIG. 4, the management apparatus 100 records Application 2 using the physical address of the beginning of the cache area AR2 as a recording start position.

When the management apparatus 100 receives the process execution request corresponding to Application 1 during the recording of Application 2 in the cache area AR2, the management apparatus 100 executes Application 1 arranged in the execution area AR1 and performs a process corresponding to Application 1, Further, the management apparatus 100 continues recording Application 2 in the cache area AR2, for example, in the background.

### (3) Arrangement of Application 3 In Cache Area AR2 (See FIG. 4)

When the management apparatus 100 completes the arrangement of Application 2 in the cache area AR2, the management apparatus 100 reads Application 3 to be executed third from the non-volatile memory based on the execution control information and records Application 3 in the cache area AR2 of the RAM. Here, the management apparatus 100 compares the data size of Application 1 (which is an application to be executed first) to the data size of Application 2 (which is an application to be executed second) and determines the recording start position from which Application 3 (which is an application to be executed third) is recorded in the cache area AR2 based on the comparison result. Then, the management apparatus 100 records Application 3 from the recording start position determined in the cache area AR2.

More specifically, for example, when the data size of Application 1 is greater than the data size of Application 2, the management apparatus 100 determines a physical address obtained by adding the data size of Application 1 to the physical address of the beginning of the cache area AR2 as a recording start position. Conversely, for example, when the data size of Application 2 is greater than the data size of Application 1, the management apparatus 100 determines a physical address obtained by adding the data size of Application 2 to the physical address of the beginning of the cache area AR2 as a recording start position.

Here, the data size of Application 1 is 384 [Kbyte] and the data size of Application 2 is 64 [Kbyte]. Accordingly, the management apparatus 100 determines the physical address obtained by adding the data size of Application 1 to the physical address of the beginning of the cache area AR2 as the recording start position and records Application 3 from the determined recording start position.

Further, the data size of the cache area AR2 is 512 [Kbyte] and the data size of Application 3 is 256 [Kbyte], Therefore, when the management apparatus 100 determines the physical address obtained by adding the data size of Application 1 to the physical address of the beginning of the cache area AR2 as the recording start position, the data size of Application 3 exceeds the cache area AR2. Accordingly, when the management apparatus 100 records Application 3 from the recording start position and the data size of Application 3 exceeds the size of the cache area AR2, a part of the data of Application 3 recordable in the cache area AR2 is recorded from the determined recording start position, as in FIG. 4. In the example of FIG. 4, the management apparatus 100 records the first half, 128 [Kbyte], of the data of Application 3 in the cache area AR2.

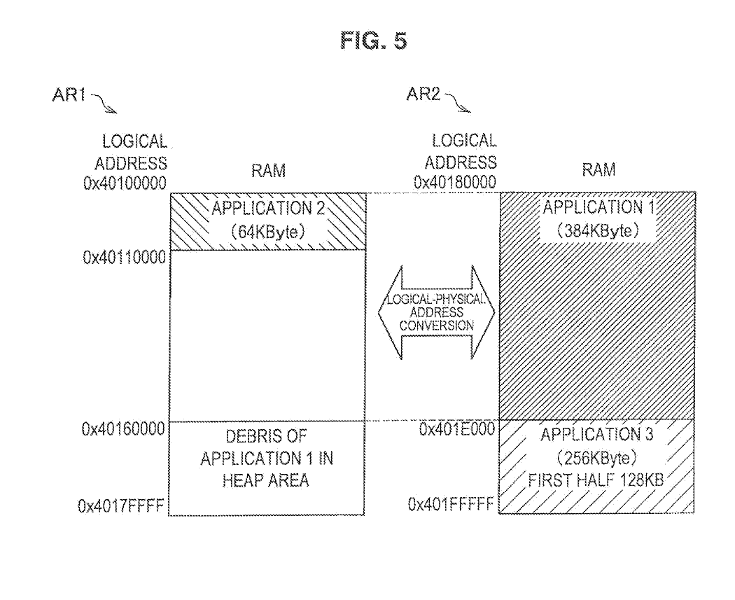

### (4) Arrangement of Application 2 In Execution Area AR1 (See FIG. 5)

When the management apparatus 100 receives the process execution request corresponding to Application 2, the management apparatus 100 performs the logical address-physical address conversion (also referred to as “logical-physical address conversion”) within a predetermined area range to transfer Application 2 stored in the cache area AR2 to the logical address of the beginning of the execution area AR1. Here, for example, a range from the physical address of the beginning of the cache area AR2 to the physical address obtained by adding a greater data size of the application between Application 1 (which is an application to be executed first) and Application 2 (which is an application to be executed second) to the physical address of the beginning of the cache area AR2 can be used as an example of the predetermined area rang according to this embodiment. That is the predetermined area range according to this embodiment corresponds to a range from the physical address of the beginning of the cache area AR2 to the physical address corresponding to the recording start position from which Application 3 (which is an application to be executed third) is recorded in the cache area AR2.

As shown in FIG. 5, the management apparatus 100 transfers Application 2 stored in the cache area AR2 to the logical address of the beginning of the execution area AR1 by performing the logical address-physical address conversion within the area range of 384 [Kbyte] from the physical address of the beginning of the cache area AR2.

Thus, through the logical address-physical address conversion, the management apparatus 100 can transfer Application 2 to the execution area AR1 without copying the data, as described above.

The management apparatus 100 does not include the recording start position from which Application 3, which is the application to be executed third, is recorded in the cache area AR2 in the predetermined area range. Accordingly, management apparatus 100 can prevent memory fragmentation in the RAM.

When the management apparatus 100 completes the arrangement of Application 2 in the execution area AR1, the management apparatus 100 executes Application 2 arranged in the execution area AR1 and performs a process corresponding to Application 2.

For example, when the management apparatus 100 performs the logical address-physical address conversion within the predetermined area range, the management apparatus 100 may erase data, which stored in the execution area AR1, other than the application stored from the logical address of the beginning of the execution area AR1 (so-called memory area initialization).

Here, erased data is highly likely to be data unrelated to the executed application, such as a part of the data (data debris) of the executed application or data stored in the heap area when the process is performed. By erasing the data, a newly executed application is prevented from referring to unrelated data stored in the execution area AR1. Accordingly, for example, the management apparatus 100 can further improve security by erasing the data.

For example, a timing at which the management apparatus 100 erases data is a timing before execution of an application. In FIG. 5, the management apparatus 100 initializes the memory area from the logical address 0x40010000 to the logical address 0x4017FFFF, for example, before executing Application 2.

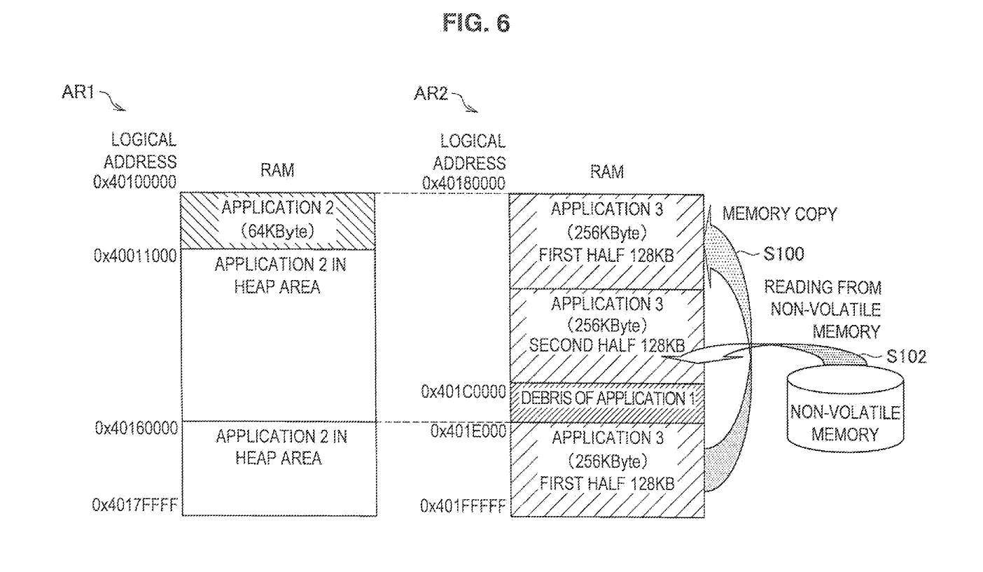

### (5) Preparing Arrangement of Application 3 In Execution Area AR1 (See FIG. 6)

When the management apparatus 100 performs the logical address-physical address conversion within the predetermined area range, the management apparatus 100 prepares the arrangement of Application 3 in the execution area AR1.

More specifically, after the management apparatus 100 performs the logical address-physical address conversion within the predetermined area range, the management apparatus 100 copies Application 3 stored in the cache area AR2 to the logical address of the beginning of the cache area AR2 (S100 in FIG. 6). In the example of FIG. 6, the management apparatus 100 overwrites Application 1 arranged in the logical address of the beginning of the cache area AR2 with Application 3 stored in the cache area AR2 through the logical address-physical address conversion.

Here, 128 [Kbyte] of Application 3 is recorded in the cache area AR2 of the RAM through the process described in (3). Therefore, when Application 3 stored in the cache area AR2 is copied to the logical address of the beginning of the cache area AR2 through the process of step S100 in FIG. 6, only a part of the data of Application 3 is arranged in the cache area AR2.

Accordingly, when Application 3 stored from the logical address of the beginning of the cache area AR2 is a part of the data of Application 3, as described above, the management apparatus 100 reads the remaining data (the second half data of 128 [Kbyte] of Application 3 from the non-volatile memory, as shown in FIG. 6. Then, the management apparatus 100 records the read data in the cache area AR2 so that the read data continues from the part of the data of Application 3 (S102 in FIG. 6).

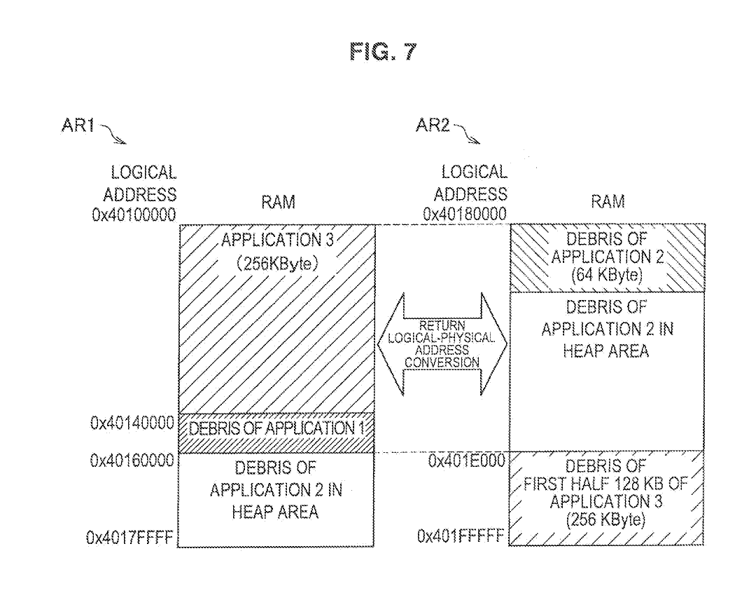

### (6) Arrangement of Application 3 In Execution Area AR1 (See FIG. 7)

When the management apparatus 100 receives the process execution request corresponding to Application 3, the management apparatus 100 transfers Application 3 stored in the cache area AR2 to the logical address of the beginning of the execution area AR1 again through the logical address-physical address conversion within the predetermined area range. Here, after the management apparatus 100 performs the logical address-physical address conversion within the predetermined area range in the process described in (4), the management apparatus 100 performs the logical address-physical address conversion within the predetermined area range again, and therefore the physical address and the logical address of the RAM coincide again.

When the management apparatus 100 completes the arrangement of Application 3 in the execution area AR1, the management apparatus 100 executes Application 3 arranged in the execution area AR1 to perform the process corresponding to Application 3.

For example, when the management apparatus 100 performs the logical address-physical address conversion within the predetermined area range, the management apparatus 100 may initialize the memory area in the execution area AR1, as in the process described in (4). In the example of FIG. 7, for example, the management apparatus 100 initializes the memory area from the logical address 0x40140000 to the logical address 0x4017FFFF before executing Application 3.

When the management apparatus 100 performs the logical address-physical address conversion within the predetermined area range again, the data size of Application 3 arranged in the cache area AR2 is greater than the data size corresponding to the predetermined area range in the process described in (5) in some cases. Here, when the data size of Application 3 is greater than the data size corresponding to the predetermined area range, the entirety of Application 3 is not transferred to the execution area AR1 in spite of the fact that the management apparatus 100 performs the logical address-physical address conversion within the predetermined area range. Accordingly, when the data size of Application 3 is greater than the data size corresponding to the predetermined area range, for example, the management apparatus 100 reads a part of the data which is not arranged in the execution area AR1 from the non-volatile memory and records the read part of the data in the physical address of the execution area AR1 so that the read part of the data continues from the data arranged in the execution area AR1.

The management apparatus 100 can manage the execution area AR1 and the cache area AR2 of the RAM based on the execution control information (the management process) and can sequentially execute Application 1 to Application 3 arranged in the execution area AR1 in response to the process execution request (the execution process), for example, by performing the processes described in (1) to (6).

The examples of the processes of the management method of the management apparatus 100 according to this embodiment in which three applications are executed in the sequence of Application 1, Application 2,and Application 3 have been described. However, the processes of the management method of the management apparatus 100 according to this embodiment are not limited thereto. For example, the management apparatus 100 can sequentially execute two applications by performing the processes described in (1), (2), (4), and (6). Further, for example, the management apparatus 100 can sequentially execute four applications by performing the processes described in (1) to (6) and then restarting the processes from the process described in (2).

The examples of the processes of the management method according to this embodiment have been described, giving the examples of the processes of the payment using electronic money (which is an example of an electronic value). However, the processes of the management method according to this embodiment are not limited to the processes of the payment. For example, the processes of the management method according to this embodiment are applicable to any process realized by sequentially executing a plurality of applications.

The management apparatus 100 according to this embodiment performs the processes (I) (management processes) or performs the processes (I) (management processes) and the processes (II) (execution processes) as the processes of the management method according to this embodiment. When the management apparatus 100 performs the processes (I) (management processes), the management apparatus 100 appropriately reads applications from a non-volatile memory such as a NAND flash memory based on the execution control information and arranges the applications in the execution area AR1 of the RAM in the application execution sequence. Here, the non-volatile memory such as a NAND flash memory is slower than the recording medium such as a RAM according to this embodiment in reading speed. However, the management apparatus 100 arranges the applications in the execution area AR1 of the RAM in the application execution sequence. Therefore, even when the plurality of applications to be executed are stored in the non-volatile memory such as a NAND flash memory, the management apparatus 100 can perform a process of switching between the applications to be executed at a higher speed.

Accordingly, the management apparatus 100 can perform efficient memory management by performing the processes of the management method according to this embodiment when the plurality of applications are sequentially executed.

As another method of implementing the process of switching between the applications to be executed at a high speed, a method of developing the applications on, for example, a ROM and executing the developed applications or a method of developing the applications or the RAM advance can be considered. However, the cost of a ROM or a RAM is higher than that of a non-volatile memory such as a NAND flash memory. Accordingly, there is a high probability that the cost of an apparatus including a recording medium managed by the management apparatus further increases when a method, other than the management method according to this embodiment is used.

According to the management method of this embodiment, the efficient memory management can be realized even when the applications to be sequentially executed are stored in a non-volatile memory such as a NAND flash memory. Accordingly, by using the management method of this embodiment, it is possible to reduce the cost of the apparatus including the recording medium managed by the management apparatus 100.

In general, when the memory management is performed through the logical address-physical address conversion of the MMU, there is a concern that the memory management may be complicated due to memory fragmentation, memory shortage, or the like.

When the management method according to this embodiment is used the memory fragmentation in the RAM (which is an example of the recording medium that temporarily stores the applications to be executed) is prevented, as described above. Further, when the management method according to this embodiment is used, the address management is further simplified. This is because the logical address-physical address conversion is performed twice within the predetermined area range so that the physical addresses coincide with the logical addresses. Accordingly, for example, since the mounting cost can be reduced, the management apparatus of this embodiment capable of performing the processes of the management method of this embodiment can be realized more easily.

### Management Apparatus According To Embodiment

Next, an example of the configuration of the management apparatus 100 of this embodiment capable of performing the processes of the management method of this embodiment will be described.

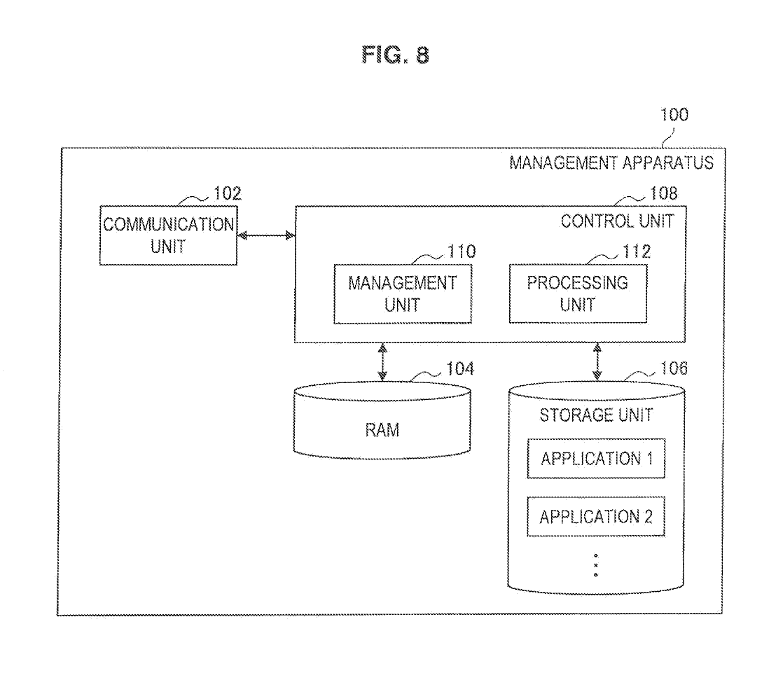

FIG. 8 is a block diagram illustrating an example of the configuration of the management apparatus 100 according to this embodiment. For example, the management apparatus 100 includes a communication unit 102, a RAM 104, a storage unit 106, and a control unit 108.

For example, the management apparatus 100 may include a ROM (not shown), an operation unit (not shown) that a user can operate, or a display unit (not shown) that displays various screens on a display screen. In the management apparatus 100, the above-described constituent elements are connected to each other via, for example, a bus that serves as a data transmission path.

Here, the ROM (not shown) stores a program such as a system program used by the control unit 108 or control data such as a calculation parameter.

For example, a button, a direction key, or a rotation type selector such as a jog dial or a combination thereof can be used as the operation unit (not shown). Further, the management apparatus 100 can be connected to an operation input device (for example, a keyboard or a mouse) as an external device of the management apparatus 100.

For example, a liquid crystal display (LCD), an organic EL display (which is also called an organic electro-luminescence display or an organic light emitting diode (OLED) display), or the like can be used as the display unit (not shown). Further, the display unit (not shown) may be a device such as a touch screen on which a displaying process or a user's operation can be performed. The management apparatus 100 can be connected to a display device (for example, an external display) as an external device of the management apparatus 100 irrespective of whether the display unit (not shown) is provided.

### Example of Hardware Configuration of Management Apparatus 100

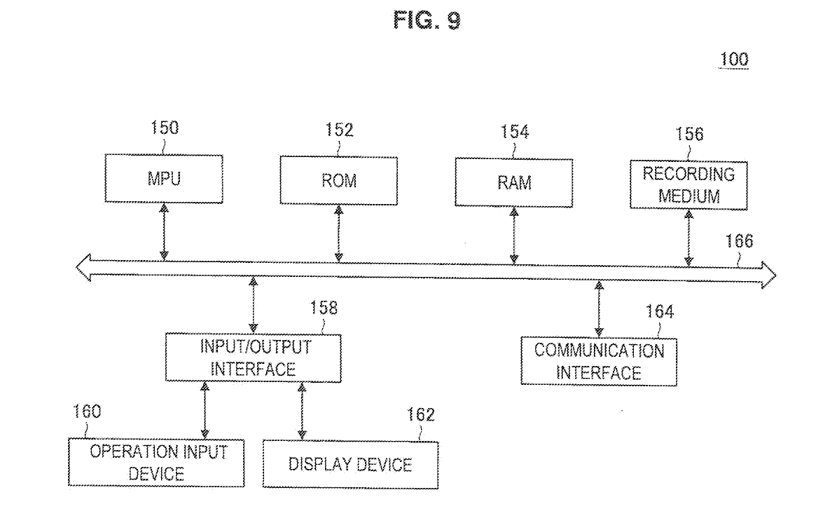

FIG. 9 is a diagram for describing an example of a hardware configuration of the management apparatus 100 according to this embodiment. For example, the management apparatus 100 includes an MPU 150, a ROM 152, a RAM 154, a recording medium 156, an input/output interface 158, an operation input device 160, a display device 162, and a communication interface 164. In the management apparatus 100, for example, the constituent elements are connected to each other via a bus 166 that serves as a data transmission path.

The MPU 150 is configured by various processing circuits such as a micro-processing unit (MPU) or an MMU. The MPU 150 functions as the control unit 108 that controls the entire management apparatus 100. Further, the MPU 150 serves as, for example, a management unit 110 and a processing unit 112 to be described below in the management apparatus 100.

For example, the ROM 152 stores a program such as a system program used by the control unit 108 or control data such as a calculation parameter.

For example, the RAM 154 temporarily stores a program or an application executed by the MPU 150. Further, the RAM 154 corresponds to the recording medium to be managed in which the management apparatus 100 manages the execution area AR1 and the cache area AR2 through the processes (I) (management processes).

The recording medium 156 functions as the storage unit 106 and stores various data such as applications. Here, examples of the recording medium 156 include a magnetic recording medium such as a hard disk or a non-volatile memory such as a flash memory. Further, the recording medium 156 may be detachably mounted on the management apparatus 100.

The input/output interface 158 is connected to, for example, the operation input device 160 or the display device 162. The operation input device 160 functions as an operation unit (not shown). The display device 162 functions as a display unit (not shown). Here, examples of the input/output interface 138 include a universal serial bus (USB) terminal, a digital visual interface (DVI) terminal, a high-definition multimedia interface (HDMI) terminal, and various processing circuits. For example, the operation input device 160 can be provided on the management apparatus 100 and is connected to the input/output interface 158 inside the management apparatus 100. For example, a button, a direction key, or a rotation type selector such as a jog dial or a combination thereof can be used as the operation input device 160. For example, the display device 162 can be provided on the management apparatus 100 and is connected to the input/output interface 158 inside the management apparatus 100. For example, a liquid crystal display or an organic EL display can be used as the display device 162.

The input/output interface 158 may, of course, be connected to an operation input device (for example, a keyboard or a mouse) as an external device of the management apparatus 100 or an external device such as a display device or the like. Further, the display device 162 may be, for example, a device such as a touch screen on which a displaying process or a user's operation can be performed.

The communication interface 164 is a communication unit included in the management device 100. The communication interface 164 functions as a communication unit 102 that communicates with an external apparatus in a wireless/wired manner via a network (or directly). Here, for example, a communication antenna and a radio frequency (RF) circuit (wireless communication), an IEEE 802.15.1 port and a transmission and reception circuit (wireless communication), an IEEE 802.11b port and a transmission and reception circuit (wireless communication), or a local area network (LAN) terminal and transmission and reception circuit (wired communication) can be used as the communication interface 164.

The management apparatus 100 having, for example, the configuration shown in FIG. 9 performs the processes of the management method according to this embodiment. The hardware configuration of tile management apparatus 100 according to this embodiment is not limited to the configuration shown in FIG. 9.

For example, the management apparatus 100 may further include a wireless communication antenna circuit and a carrier-wave transmission circuit to communicate with an external apparatus via a communication path formed by near field communication (NFC) that is used for communication using carrier waves with a predetermined frequency such as 13.56 [MHz].

Here, for example, the wireless communication antenna circuit includes a demodulation circuit and a resonance circuit that includes a coil with a predetermined inductance as a transmission and reception antenna and a capacitor with a predetermined electrostatic capacitance. Further, the carrier-wave transmission circuit includes a modulation circuit that performs amplitude shift keying (ASK) modulation and an amplification circuit that amplifies an output from the modulation circuit. The carrier-wave transmission circuit transmits carrier waves having carrier-wave signals from the transmission and reception antenna of the wire less communication antenna circuit.

When the management apparatus 100 includes the wireless communication antenna circuit and the carrier-wave transmission circuit, the management apparatus 100 can have a so-called reader/writer function. Further, the management apparatus 100 may include an IC chip capable of communicating with a reader/writer contactless way.

When the management apparatus 100 is configured as a stand-alone type apparatus to perform the processes, the management apparatus 100 may not include the communication device 164. Further, the management apparatus 100 may not include, for example, the RAM 154, the recording medium 156, the operation device 160, or the display device 162.

The management apparatus 100 may be configured as an IC that realizes a function (for example, the function of the management unit 110 to be described below or the functions of the management unit 110 to be described below and the processing unit 112 to be described below) of performing the processes of the management method according to this embodiment.

Referring. back to FIG. 8, an example of the configuration of the management apparatus 100 will be described. The communication unit 102 is a communication unit included in the management apparatus 100 and communicates with an external apparatus in a wireless/wired manner via a network (or through direct connection). Further, the communication of the communication unit 102 is controlled by, for example, the control unit 108. When the management apparatus 100 includes the communication unit 102, the management apparatus 100 can perform the processes of the management method according to this embodiment based on execution control information or a process execution request transmitted from an external apparatus.

Here, for example, a communication antenna and an RF circuit, a LAN terminal and a transmission and reception circuit, or the like can be used as the communication unit 102, but the configuration of the communication unit 102 is not limited to the above-described configurations. For example, the communication unit 102 may have a configuration of a USB terminal and a transmission and reception circuit corresponding to any standard capable of performing communication or a configuration corresponding to a network.

For example, the RAM 104 is a recording medium that temporarily stores a program, an application, or the like to be executed. For example, the RAM 104 has the configuration shown in A of FIG. 1. The execution area AR1 and the cache area AR2 of the RAM 104 are managed by the management unit 110 to be described below.

The storage unit 106 is a storage unit included in the management apparatus 100 and stores various data such as applications. Here, examples of the storage unit (not shown) include a magnetic recording medium such as a hard disk or a non-volatile memory such as a flash memory. Further, the storage on (not shown) may be detachably mounted on the management apparatus 100.

The control Unit 108 is configured by, for example, an MPU and serves as a unit that controls the entire management apparatus 100. Further, the control unit 108 includes, for example, the management unit 110 and the processing unit 112. The control unit 108 serves as a unit that leads the processes of the management method according to this embodiment.

The management unit 110 serves as a unit that leads the processes (I) (management processes) and manages the execution area AR1 and the cache area AR2 of the RAM 104 based on the execution control information. More specifically, for example, the management unit 110 leads the processes other than the processes of executing the applications among the processes of the management method described with reference to FIGS. 2 to 7 according to this embodiment.

The processing unit 112 serves as a unit that leads the processes (II) (execution processes). The processing unit 112 executes the application stored in the execution area AR1 of the RAM 104 and causes the executed application to perform a process. More specifically, for example, the management unit 110 leads the process of executing the application among the processes of the management method described with reference to FIGS. 2 to 7 according to this embodiment.

The control unit 108 includes, for example, the management unit 110 and the processing unit 112, and thus leads the processes of the management method according to this embodiment.

The configuration for realizing the processes of the management method according to this embodiment is not limited to the configuration of the control unit 108 shown in FIG. 8. For example, the control unit 108 according to this embodiment may not include the processing unit 112. When the control unit 108 does not include the processing unit 112, for example, the applications stored in the execution area AR1 of the RAM 104 are executed by an external apparatus. Here, even when the control unit 108 does not include the processing unit 112, the management apparatus according to this embodiment can perform the processes (I) (management processes) of the management method according to this embodiment. Accordingly, even in a case in which the control unit 108 does not include the processing unit 112, the management apparatus 100 according to this embodiment can perform efficient memory management when a plurality of applications are sequentially executed.

The management apparatus 100 having, for example, the configuration shown in FIG. 8 performs the processes (for example, the processes (I) (management processes)) of the management method according to this embodiment. Accordingly, the management apparatus 100 having, for example, the configuration shown in FIG. 8 can perform efficient memory management when a plurality applications are sequentially executed.

Further, the management apparatus 100 having, for example, the configuration shown in FIG. 8 further performs the processes (II) (execution processes). Accordingly, the management apparatus 100 can execute the applications stored in the execution area AR1 of the RAM 104 and cause the applications to perform processes in response to a process execution request, as in the examples of the processes of the management method described with reference to FIGS. 2 to 7 according to this embodiment.

The configuration of the management apparatus according to this embodiment is not limited to the configuration shown in FIG. 8. For example, when the management apparatus according to this embodiment is configured as a stand-alone type apparatus to perform the processes, the management apparatus according to this embodiment may not include the communication unit 102.

When the management unit 110 that leads the processes (I) (management processes) of the management method according to this embodiment manages, for example, an external recording medium installed outside the management apparatus 100 according to this embodiment, the management apparatus 100 according to this embodiment may not include the RAM 104 (which is an example of a recording medium that temporarily stores a program or an application to be executed).

The management apparatus 100 according to this embodiment may not include the storage unit 106. When the management apparatus 100 does not include the storage unit 106, the management apparatus 100 according to this embodiment acquires applications from an external apparatus connected via a network (or connected directly).

As described above, the management apparatus 100 according to this embodiment performs, for example, the processes (I) (management processes) or performs the processes (I) (management processes) and the processes (II) (execution processes) as the processes of the management method according to this embodiment. The management apparatus 100 appropriately reads applications from, for example, a non-volatile memory in the processes (I) (management processes) based on the execution control information and arranges the applications in the execution area AR1 of the RAM (which is an example of a recording medium that temporarily stores programs or applications to be executed) in the application execution sequence. The management apparatus 100 arranges the applications in the execution area AR1 of the RAM in the application execution sequence. Therefore, even when a plurality of applications to be executed are stored in a non-volatile memory such as a NAND flash memory which is slower than a RAM in reading speed, the management apparatus 100 can perform the process of switching between the applications to be executed at a higher speed.

Accordingly, even when the plurality of applications are sequentially executed, the management apparatus 100 can perform efficient memory management.

Further, the efficient memory management can be performed in accordance with the management method according to this embodiment, even when the applications to be sequentially executed are stored in a non-volatile memory such as a NAND flash memory. Accordingly, the cost of the apparatus including the recording medium managed by the management apparatus 100 can be reduced by using the management method according to this embodiment.

When the management method according to this embodiment is used, memory fragmentation in the RAM is prevented. Further, when the management method according to this embodiment is used, the address management is further simplified. This is because the logical address-physical address conversion is performed twice within the predetermined area range so that the physical addresses coincide with the logical addresses. Accordingly, for example, since the mounting cost can be reduced, the management apparatus of this embodiment capable of performing the processes of the management method of this embodiment can be realized more easily.

The embodiment of the management apparatus 100 has been described, but embodiments of the present disclosure are not limited thereto. This embodiment is applicable to various apparatuses such as a computer such as a personal computer (PC) or a server, a display apparatus such as a television receiver, a communication apparatus such as a portable telephone or a smart phone, a video/music reproduction apparatus (or a video/music recording and reproduction apparatus), and a game console. Further, the embodiment is applicable to a recording medium control IC which can be embedded in various apparatuses described above.

### Program According To Embodiment

Efficient memory management can be realized when a plurality of applications are sequentially executed by a program (a program capable of performing the processes, such as the processes (I) (management processes) or performing the processes (I) management processes) and the processes (II) (execution processes), of the management method according to this embodiment) causing a computer to function as the management apparatus according to this embodiment.

The preferred embodiment of the present disclosure has been described in detail with reference to the accompanying drawings, but the technical scope of an embodiment of the present disclosure is not limited thereto. It should be apparent to those skilled in the art of the present disclosure, that various modified examples or corrected examples are made within the scope of the technical spirit described in claims, and the modified examples or the corrected examples, of course, pertain to the technical scope of the present disclosure.

For example, the program (computer program) causing a computer to function as the management apparatus according to this embodiment has been provided. In this embodiment, however, a recording medium storing this program may also be provided.

The above-described configurations are merely examples of the embodiment and, of course, pertain to the technical scope of the present disclosure.

Additionally, the present technology may also be configured as below
(1) A management apparatus comprising:

a management unit that manages, based on execution control information indicating an execution sequence of a plurality of applications, an execution area and a cache area of a recording medium which temporarily stores the applications when the applications are executed.
(2) The management apparatus according to (1),

wherein the management unit
records an application to be executed first using, a physical address of a beginning of the execution area as a recording start position,
records an application to be executed second using a physical address of a beginning of the cache area as a recording start position, and
transfers the application to be executed second, which is stored in the cache area, to a logical address of the beginning of the execution area by performing logical address-physical address conversion within a predetermined area range when executing the application to be executed second, and

wherein the predetermined area range is a range from the physical address of the beginning of the cache area to a physical address obtained by adding a greater data size of the application between the application to be executed first and the application to be executed second to the physical address of the beginning of the cache area.
(3) The management apparatus according to (2), wherein, when an application to be executed third is present, the management unit determines a recording start position from which the application to be executed third is recorded in the cache area based on a result obtained by comparing the data size of the application to be executed first to the data size of the application to be executed second, and records the application to be executed third from the recording start position determined in the cache area.
(4) The management apparatus according to (3),

wherein, when the data size of the application to be executed first is greater than the data size of the application to be executed second, the management unit determines, as the recording start position, a physical address obtained by adding the data size of the application to be executed first to the physical address of the beginning of the cache area, and

when the data size of the application to be executed second is greater than the data site of the application to be executed first, the management unit determines, as the recording start position, a physical address obtained by adding the data size of the application to be executed second to the physical address of the beginning of the cache area.
(5) The management apparatus according to (4), wherein, when the management unit records the application to be executed third from the determined recording start position and a data size of the application to be executed third exceeds a size of the cache area, the management unit records a part of the data of the application to be executed third, which is recordable in the cache area, from the determined recording start position.
(6) The management apparatus according to (4) or (5), wherein, after the management unit performs the logical address-physical address conversion within the predetermined area range, the management unit copies the application to be executed third, which is stored from the determined recording start position in the cache area, to a logical address of the beginning of the cache area.
(7) The management apparatus according to (6), wherein, when the application to be executed third, which is stored from the logical address of the beginning of the cache area, is a part of the data of the application to be executed third, the management unit records remaining data of the application to be executed third in the cache area so that the remaining data continues from the part of the data.
(8) The management apparatus according to (6) or (7), wherein, when the management unit executes the application to be executed third, the management unit transfers the application to be executed second, which has been transferred to the execution area, to the logical address of the beginning of the cache area by performing the logical address-physical address conversion within the predetermined area range.
(9) The management apparatus according to any one of (2) to (8), wherein, when the management unit performs the logical address-physical address conversion within the predetermined area range, the management unit erases data stored in the execution area except for the application stored from the logical address of the beginning of the execution area.
(10) The management apparatus according to any one of (1) to (9), further comprising:

a communication unit that communicates with an external apparatus,

wherein the management unit manages the execution area and the cache area of the recording medium based on the execution control information transmitted from the external apparatus.
(11) The management apparatus according to any one of (1) to (10), further comprising

a processing unit that causes the application stored in the execution area to perform a process.
(12) The management apparatus according to (11), further comprising:

a communication unit that communicates with an external apparatus,

wherein the processing unit causes the application to perform the process in response to a process execution request transmitted from the external apparatus.
(13) The management apparatus according to any one of (1) to (12), comprising:

the recording medium.
(14) The management apparatus according to any one of (1) to (12), wherein the recording medium is an external recording medium installed outside.
(15) A management method comprising:

managing, based on execution control information indicating an execution sequence of a plurality of applications, an execution area and a cache area of a recording medium which temporarily stores the applications when the applications are executed.
(16) A program for causing a computer to realize a function of managing, based on execution control information indicating an execution sequence of a plurality of applications, an execution area and a cache area of a recording medium which temporarily stores the applications when the applications are executed.

The present disclosure contains subject matter related to that disclosed in Japanese Priority Patent Application JP 2011-227957 flied in the Japan Patent Office on Oct. 17, 2011, the entire content of which is hereby incorporated by reference.

What is claimed is:

1. A management apparatus comprising:
a management unit that manages, based on execution control information indicating an execution sequence of a plurality of applications, an execution area and a cache area of a recording medium which temporarily stores the applications when the applications are executed.

2. The management apparatus according to claim 1,
wherein the management unit
records an application to be executed first using a physical address of a beginning of the execution area as a recording start position,
records an application to be executed second using a physical address of a beginning of the cache area as a recording start position, and
transfers the application to be executed second, which is stored in the cache area, to a logical address of the beginning of the execution area by performing logical address-physical address conversion within a predetermined area range when executing the application to be executed second, and
wherein the predetermined area range is a range from the physical address of the beginning of the cache area to a physical address obtained by adding a greater data size of the application between the application to be executed first and the application to be executed second to the physical address of the beginning of the cache area.

3. The management apparatus according to claim 2, wherein, when an application to be executed third is present, the management unit determines a recording start position from which the application to be executed third is recorded in the cache area based on a result obtained by comparing the data size of the application to be executed first to the data size of the application to be executed second, and records the application to be executed third from the recording start position determined in the cache area.

4. The management apparatus according to claim 3,
wherein, when the data size of the application to be executed first is greater than the data size of the application to be executed second, the management unit determines, as the recording start position, a physical address obtained by adding the data size of the application to be executed first to the physical address of the beginning of the cache area, and
when the data size of the application to be executed second is greater than the data size of the application to be executed first, the management unit determines, as the recording start position, a physical address obtained by adding the data size of the application to be executed second to the physical address of the beginning of the cache area.

5. The management apparatus according to claim 4, wherein, when the management unit records the application to be executed third from the determined recording start position and a data size of the application to be executed third exceeds a size of the cache area, the management unit records a part of the data of the application to be executed third, which is recordable in the cache area, from the determined recording start position.

6. The management apparatus according to claim 4, wherein, after the management unit performs the logical address-physical address conversion within the predetermined area range, the management unit copies the application to be executed third, which is stored from the determined recording start position in the cache area, to a logical address of the beginning of the cache area.

7. The management apparatus according to claim 6, wherein, when the application to be executed third, which is stored from the logical address of the beginning of the cache area, is a part of the data of the application to be executed third, the management unit records remaining data of the application to be executed third in the cache area so that the remaining data continues from the part of the data.

8. The management apparatus according to claim 6, wherein, when the management unit executes the application to be executed third, the management unit transfers the application to be executed second, which has been transferred to the execution area, to the logical address of the beginning of the cache area by performing the logical address-physical address conversion within the predetermined area range.

9. The management apparatus according to claim 2, wherein, when the management unit performs the logical address-physical address conversion within the predetermined area range, the management unit erases data stored in the execution area except for the application stored from the logical address of the beginning of the execution area.

10. The management apparatus according to claim 1, further comprising:
a communication unit that communicates with an external apparatus,
wherein the management unit manages the execution area and the cache area of the recording medium based on the execution control information transmitted from the external apparatus.

11. The management apparatus according to claim 1, further comprising:
a processing unit that causes the application stored in the execution area to perform a process.

12. The management apparatus according to claim 11, further comprising:
a communication unit that communicates with an external apparatus,
wherein the processing unit causes the application to perform the process in response to a process execution request transmitted from the external apparatus.

13. The management apparatus according to claim 1, comprising:
the recording medium.

14. The management apparatus according to claim 1, wherein the recording medium is an external recording medium installed outside.

15. A management method comprising:
managing, based on execution control information indicating an execution sequence of a plurality of applications, an execution area and a cache area of a recording medium which temporarily stores the applications when the applications are executed.

16. A program for causing a computer to realize a function of managing, based on execution control information indicating an execution sequence of a plurality of applications, an execution area and a cache area of a recording medium which temporarily stores the applications when the applications are executed.
